(19) United States
(12) Patent Application Publication
(10) Pub. No.: US 2025/0182623 A1
(43) Pub. Date: Jun. 5, 2025

(54) HEADS-UP AREA SETTING DEVICE, HEADS-UP AREA SETTING METHOD, AND RECORDING MEDIUM

(71) Applicant: NEC Corporation, Minato-ku, Tokyo (JP)

(72) Inventors: Takumi SHIBA, Tokyo (JP); Takashi Nunomoto, Tokyo (JP); Sawaka SEKI, Tokyo (JP); Masaru YANAI, Tokyo (JP); Kosei KOBAYASHI, Tokyo (JP); Hitomi ITO, Tokyo (JP); Yoko TANAKA, Tokyo (JP); Seito NAGASHIMA, Tokyo (JP)

(73) Assignee: NEC Corporation, Minato-ku, Tokyo (JP)

(21) Appl. No.: 18/839,773

(22) PCT Filed: Feb. 24, 2022
(86) PCT No.: PCT/JP2022/007485

§ 371 Date: Aug. 20, 2024

(51) Int. Cl. G08G 1/16; G06V 20/58

(52) U.S. Cl. CPC G08G 1/166; G06V 20/58; G06V 2201/08

(57) ABSTRACT

A heads-up area setting device according to an aspect of the present disclosure includes at least one memory configured to store instructions; and at least one processor configured to execute the instructions to: detect a moving object located in a predetermined monitoring area; and determine a range of a heads-up area based on an arrangement situation of the moving object in the monitoring area.

### TECHNICAL FIELD

The present invention relates to a heads-up area setting device, a heads-up area notification system, a heads-up area setting method, and a recording medium.

### BACKGROUND ART

Based on Article 24 of the Basic Law for Traffic Safety Measures, school zones are provided around elementary schools and kindergartens throughout the country.

PTL 1 discloses a map data generation device capable of appropriately specifying an area where a vehicle or the like should be notified of the presence of a pedestrian carrying a mobile terminal when the pedestrian is present. Specifically, PTL 1 describes that an area satisfying conditions such as a predetermined range from the entrance to a school facility, a densely populated residential area, and a general road or a narrow street is set as a school zone. PTL 1 describes that the presence of a school zone or a pedestrian (terminal) around the in-vehicle terminal is presented to the in-vehicle terminal (claim 3 and the like).

PTL 2 discloses a configuration in which, in a vehicle sign display device that displays both normal maximum speed information and maximum speed information of a school zone, when a predetermined number or more of obstacles are detected around the vehicle, the maximum speed information of the school zone is highlighted.

### CITATION LIST

### Patent Literature

PTL 1: JP 2011-087170 A
PTL 2: JP 2017-117040 A

### SUMMARY OF INVENTION

### Technical Problem

In a general school zone, there is a problem that only a preset area is a target of speed restriction and passage direction restriction but restrictions cannot be applied to other areas. This point is the same in PTL 1, and only an area satisfying conditions such as a predetermined range from the entrance to the school facility, a densely populated residential area, and a general road or a narrow street is set as a school zone. There is another problem that calling attention for an unnecessarily wide area reduces the effect of calling attention.

There is a need to monitor all moving objects, such as bicycles and delivery robots, in addition to pedestrians to ensure their safe movements.

It is an object of the present invention to provide a heads-up area setting device, a heads-up area notification system, a heads-up area setting method, and a recording medium that can contribute to improving the safety of moving objects more appropriately.

### Solution to Problem

According to a first aspect, there is provided a heads-up area setting device including a detection means for detecting a moving object located in a predetermined monitoring area and an area setting means for determining a range of a heads-up area based on an arrangement situation of the moving object in the monitoring area.

According to a second aspect, there is provided a heads-up area notification system including a detection means for detecting a moving object located in a predetermined monitoring area, an area setting means for determining a range of a heads-up area based on an arrangement situation of the moving object in the monitoring area, and a notification means for transmitting a notification for informing of presence of the heads-up area to a vehicle entering the heads-up area.

According to a third aspect, there is provided a heads-up area setting method including detecting a moving object located in a predetermined monitoring area and determining a range of a heads-up area based on an arrangement situation of the moving object in the monitoring area.

According to a fourth aspect, there is provided a computer-readable recording medium storing a program causing a computer to execute processing for detecting a moving object located in a predetermined monitoring area and processing for determining a range of a heads-up area based on an arrangement situation of the moving object in the monitoring area.

### Advantageous Effects of Invention

According to the present invention, there are provided a heads-up area setting device, a heads-up area notification system, a heads-up area setting method, and a recording medium that can contribute to improving the safety of moving objects more appropriately.

### BRIEF DESCRIPTION OF DRAWINGS

FIG. 1 is a diagram illustrating the configuration of an example embodiment of the present invention.

FIG. 2 is a diagram illustrating the operation of the example embodiment of the present invention.

FIG. 3 is a diagram illustrating the operation of the example embodiment of the present invention.

FIG. 4 is a diagram illustrating the operation of the example embodiment of the present invention.

FIG. 5 is a diagram illustrating the configuration of a heads-up area notification system according to a first example embodiment of the present invention.

FIG. 6 is a flowchart illustrating an operation (update of the heads-up area) of the heads-up area notification system according to the first example embodiment of the present invention.

FIG. 7 is a diagram for explaining a method of setting a heads-up area by the heads-up area notification system according to the first example embodiment of the present invention.

FIG. 8 is a flowchart illustrating an operation (notification based on the heads-up area) of the heads-up area notification system according to the first example embodiment of the present invention.

FIG. 9 is a diagram illustrating the configuration of a heads-up area notification system according to a second example embodiment of the present invention.

FIG. 10 is a diagram illustrating an example of a heads-up area set by the heads-up area notification system according to the second example embodiment of the present invention.

FIG. 11 is a diagram illustrating another example of the heads-up area set by the heads-up area notification system according to the second example embodiment of the present invention.

FIG. 12 is a diagram illustrating another example of the heads-up area set by the heads-up area notification system according to the second example embodiment of the present invention.

FIG. 13 is a diagram illustrating the configuration of a heads-up area notification system according to a third example embodiment of the present invention.

FIG. 14 is a diagram illustrating the configuration of a computer forming the heads-up area notification system of the present invention.

### EXAMPLE EMBODIMENT

First, an outline of an example embodiment of the present invention will be described with reference to the diagrams. Reference numerals in the diagrams given to the outline are given to each element for convenience as an example to facilitate understanding, and are not intended to limit the present invention to the illustrated aspects. Connection lines between blocks in the diagrams and the like referred to in the following description include both bidirectional and unidirectional. The unidirectional arrow schematically indicates a flow of a main signal (data), and does not exclude bidirectionality. A program is executed through a computer device, and the computer device includes, for example, a processor, a storage device, an input device, a communication interface, and a display device as necessary. The computer device is configured to be able to communicate with a device (including a computer) inside or outside the device through a communication interface regardless of wired or wireless. Although ports and interfaces are provided at connection points of input and output of each block in the diagram, illustration thereof is omitted.

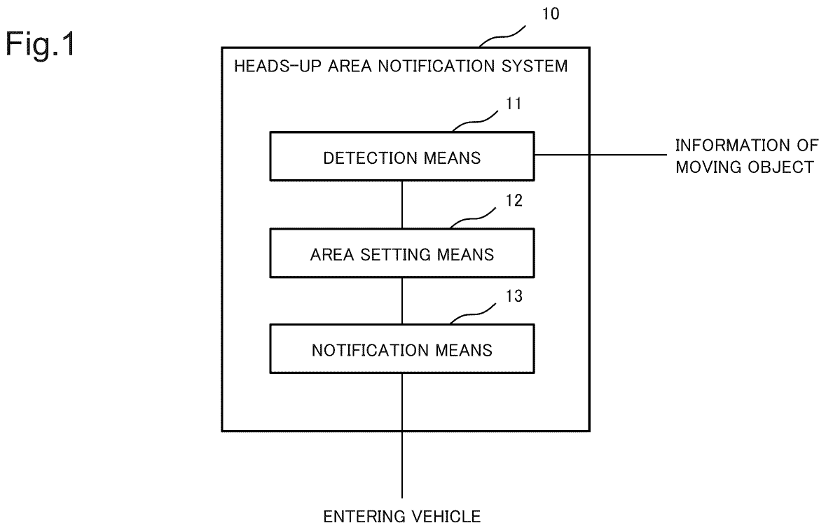

In one example embodiment of the present invention, as illustrated in FIG. 1, the present invention can be implemented by a heads-up area notification system 10 including a detection means 11, an area setting means 12, and a notification means 13.

More specifically, the detection means 11 detects a moving object located in a predetermined monitoring area. Examples of the moving object include a pedestrian, a bicycle, an automatic guided vehicle, and a specific vehicle.

The area setting means 12 determines the range of the heads-up area based on the arrangement situation of the moving objects in the monitoring area.

The notification means 13 transmits a notification for informing of the presence of the heads-up area to a vehicle entering the heads-up area.

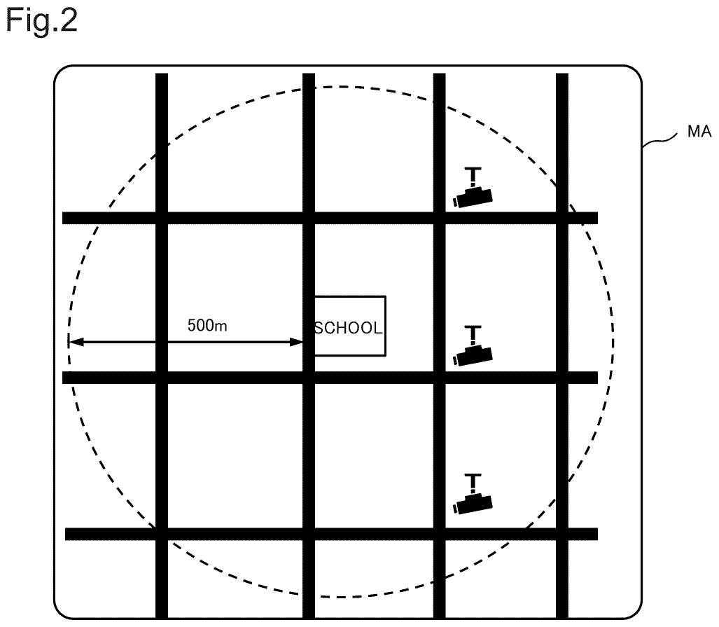

FIG. 2 illustrates a map of a school in a predetermined area and its surrounding area. A circle having a radius of 500 m in the diagram indicates a range used as a set range of the school zone. An area MA indicated by a broken line indicates a monitoring area where the detection means 11 detects the moving object.

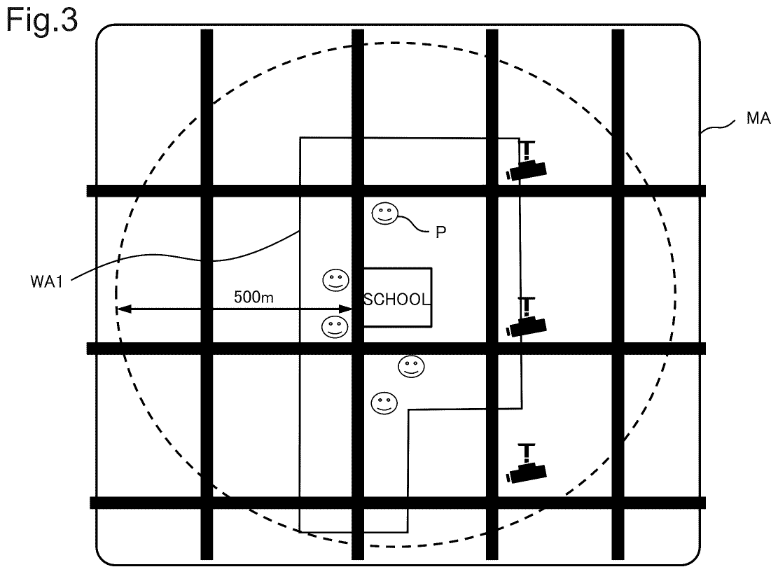

FIG. 3 is a diagram illustrating an example of the heads-up area set by the area setting means 12. Five face marks represented by reference sign P in the diagram indicate pedestrians. In the example of FIG. 3, the area setting means 12 determines the heads-up area covering the position of the moving object as illustrated in FIG. 3. The notification means 13 transmits a notification for informing of the presence of the heads-up area to a vehicle entering such a heads-up area. This notification may include information indicating the presence of a pedestrian, speed restriction, and the like, in addition to the presence of the heads-up area.

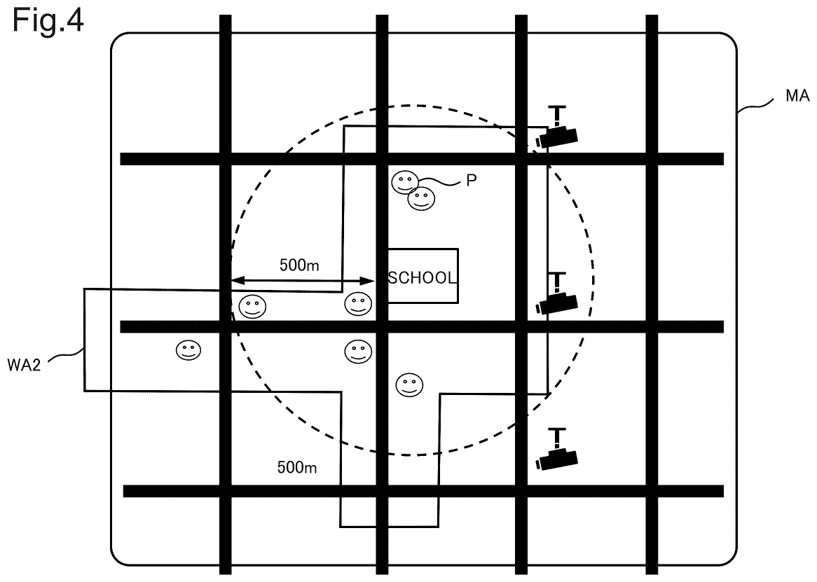

The above-described heads-up area is updated according to a change in the arrangement situation of moving objects. For example, when the arrangement situation of moving objects illustrated in FIG. 4 is obtained after the elapse of a predetermined time from the state of FIG. 3, the area setting means 12 expands the heads-up area according to the arrangement situation of moving objects. By changing the shape (range) of the heads-up area according to the change in the arrangement situation of moving objects in this manner, it is possible to appropriately warn the vehicle entering the heads-up area.

Needless to say, the heads-up area may be reduced or deleted. For example, when the arrangement situation of moving objects illustrated in FIG. 3 is obtained after the elapse of a predetermined time from the state of FIG. 4, the area setting means 12 may return the heads-up area to the original size. As shown in FIG. 2, when there is no moving object, the area setting means 12 may delete the heads-up area.

As described above, by setting the heads-up area based on the position of the moving object and giving a necessary warning, safe movement of the moving object can be achieved. The heads-up area notification system 10 in FIG. 1 can also be configured by two devices of a heads-up area setting device including the detection means 11 and the area setting means 12 and a notification device including the notification means 13.

### First Example Embodiment

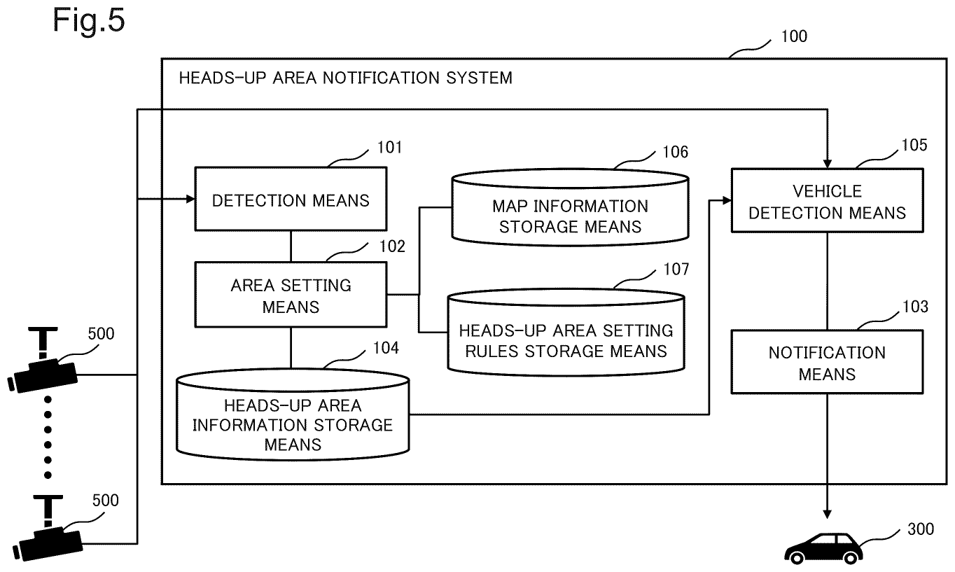

Next, a first example embodiment of the present invention will be described in detail with reference to the diagrams. FIG. 5 is a diagram illustrating the configuration of a heads-up area notification system according to the first example embodiment of the present invention. Referring to FIG. 5, a configuration including a plurality of cameras 500, a heads-up area notification system 100, and a vehicle 300 as a notification destination of a notification based on the heads-up area is illustrated.

The camera 500 is installed at each place in the monitoring area to be monitored by the heads-up area notification system 100, and provides a captured image to the heads-up area notification system 100. As the camera 500, various security cameras or traffic flow monitoring cameras installed near intersections and roads can be used. As the camera 500, a multi-function terminal with a camera called a smart pole can also be used.

The heads-up area notification system 100 includes a detection means 101, an area setting means 102, a notification means 103, a heads-up area information storage means 104, a vehicle detection means 105, a map information storage means 106, and a heads-up area setting rules storage means 107.

The detection means 101 detects a pedestrian as a moving object located in the monitoring area based on the image acquired from the camera 500, and specifies the position of the pedestrian. The position of the pedestrian can be determined by the installation position of the camera 500, the position and size of the pedestrian in the image, and the like. In the present example embodiment, a pedestrian is detected by the camera 500. However, for example, when the heads-up area notification system 100 can obtain position information from a mobile terminal carried by the pedestrian, the pedestrian and its position may be detected using the information. For example, it is also possible to adopt a method in which a roadside device performs short-range wireless communication with a mobile terminal to detect a moving object and its attributes.

The map information storage means 106 stores map information including a monitoring area to be monitored by the heads-up area notification system 100.

The heads-up area setting rules storage means 107 stores rules for setting the heads-up area based on the arrangement situation of the pedestrian detected by the detection means 101. Examples of the rules include a method of setting a heads-up area based on the presence or absence or density of pedestrians in a grid (section) set in the monitoring area described above. A specific method of setting the heads-up area will be described later together with the operation of the heads-up area notification system 100.

The area setting means 102 sets the heads-up area on the map read from the map information storage means 106, based on the arrangement situation of the pedestrians detected by the detection means 101, using the rules. The area setting means 102 stores the set heads-up area in the heads-up area information storage means 104.

The heads-up area information storage means 104 provides information of the heads-up area to the vehicle detection means 105.

The vehicle detection means 105 detects a vehicle that has entered the heads-up area based on the image acquired from the camera 500 and the information of the heads-up area acquired from the heads-up area information storage means 104. The vehicle detection means 105 requests the notification means 103 to transmit a notification for informing of the presence of the heads-up area to the vehicle that has entered the heads-up area.

The notification means 103 transmits, based on a request from the vehicle detection means 105, a notification for informing of the presence of the heads-up area to the vehicle that has entered the heads-up area through a roadside device installed around a road or at an intersection or a base station. As a method in which the notification means 103 selectively transmits a notification to a vehicle that has entered the heads-up area, it is possible to adopt a method of broadcasting a notification including information for identifying a notification target vehicle and identifying that the notification is a notification to the host vehicle on the vehicle side. As a method in which the notification means 103 transmits a notification to a vehicle that has entered the heads-up area, a method of directly transmitting the notification to the vehicle in a unicast manner can also be adopted. In this case, the vehicle detection means 105 reads identification information such as license plate information of the vehicle, and acquires a communication address or the like of the vehicle from an external server or the like based on the identification information.

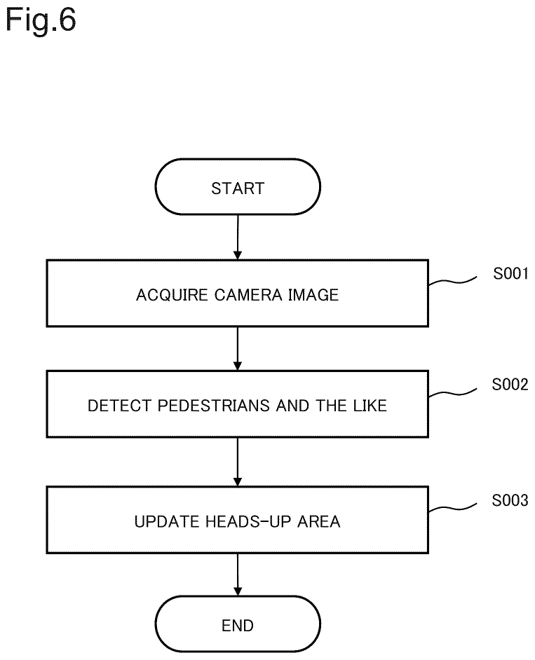

Next, the operation of the present example embodiment will be described in detail with reference to the diagrams. FIG. 6 is a flowchart illustrating an operation (update of the heads-up area) of the heads-up area notification system 100 according to the first example embodiment of the present invention. Referring to FIG. 6, first, the heads-up area notification system 100 acquires image data from the camera 500 (step S001).

Then, the heads-up area notification system 100 detects pedestrians and the like, specifies the positions of the pedestrians and the like, and grasps a distribution situation (arrangement situation) (step S002).

The heads-up area notification system 100 updates the heads-up area based on the grasp of the distribution situation (arrangement situation) of the pedestrians (step S003).

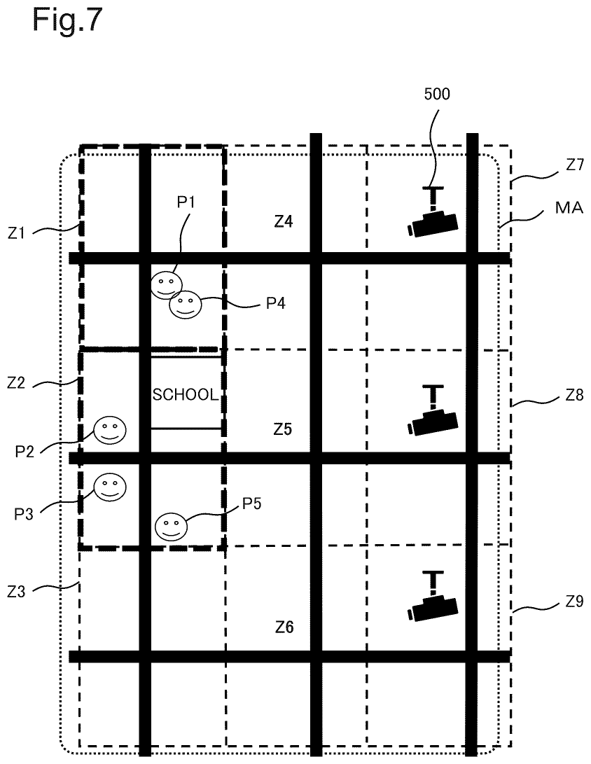

FIG. 7 is a diagram for explaining an example of a method of setting a heads-up area by the heads-up area notification system 100. The monitoring area MA in FIG. 7 is divided into three grids (sections) of 3×3. Here, for example, when a rule that when m or more (m≥1) pedestrians are present per grid (section), the grid (section) is set as a heads-up area is defined, the heads-up area notification system 100 selects grids (sections) denoted by reference numerals Z1 and Z2 in FIG. 7 where pedestrians P1 to P5 are present, and sets the grids (sections) as heads-up areas. As described above, the heads-up area can be set by selecting an area in which the density of moving objects is equal to or greater than a predetermined value. The threshold value m described above can be appropriately changed according to the type of the moving object, the purpose of calling attention, and the like.

The heads-up area can also be set by excluding an area in which the density of the moving object is equal to or less than a predetermined value. For example, when the number of pedestrians per grid (section) is n or less (n≥0), the heads-up area can be set by excluding the grid (section) from the heads-up area. In the example of FIG. 7, the heads-up area can be set by excluding grids (sections) Z3 to Z9 where pedestrians P1 to P5 are not present from the entire monitoring area MA. The threshold value n described above can be appropriately changed according to the type of the moving object, the purpose of calling attention, and the like. For example, values of 1 or more can be set.

The heads-up area notification system 100 executes the above-described heads-up area update processing every predetermined time, and updates the heads-up area according to the distribution situation (arrangement situation) of pedestrians. The grid (section) illustrated in FIG. 7 is merely an example, and a finer grid (section) can be set according to the position detection accuracy of the detection means 101 or the like.

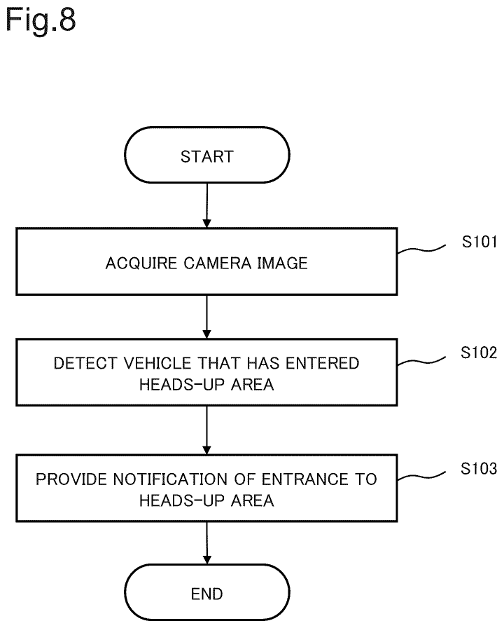

FIG. 8 is a flowchart illustrating an operation (notification based on the heads-up area) of the heads-up area notification system 100 according to the first example embodiment of the present invention. Referring to FIG. 8, first, the heads-up area notification system 100 acquires image data from the camera 500 (step S101).

Then, the heads-up area notification system 100 detects a vehicle that has entered the heads-up area, specifies the position of the vehicle, and grasps a distribution situation (arrangement situation) (step S102).

Then, the heads-up area notification system 100 transmits a notification for informing of the presence of the heads-up area to the vehicle that has entered the heads-up area (step S103). This notification can include not only notification that the vehicle has entered the heads-up area but also speed limit applied in the heads-up area, the presence of a pedestrian, and the like.

As described above, according to the present example embodiment, it is possible to dynamically set a heads-up area according to the distribution situation (arrangement situation) of pedestrians and give a warning to a vehicle entering the heads-up area. In the example embodiment described above, an example has been described in which the heads-up area is set around the school as illustrated in FIG. 7, but this heads-up area can be operated as an area equivalent to the school zone. At this time, in the present example embodiment, in comparison with the fixed school zone described in the Background Art, a road on which there is no pedestrian (child) can be excluded from the heads-up area regardless of whether the road is included in the conventional school zone. The present example embodiment has a remarkable effect that a road on which a pedestrian (child) is present can be included in the heads-up area regardless of whether the road is included in the conventional school zone.

### Second Example Embodiment

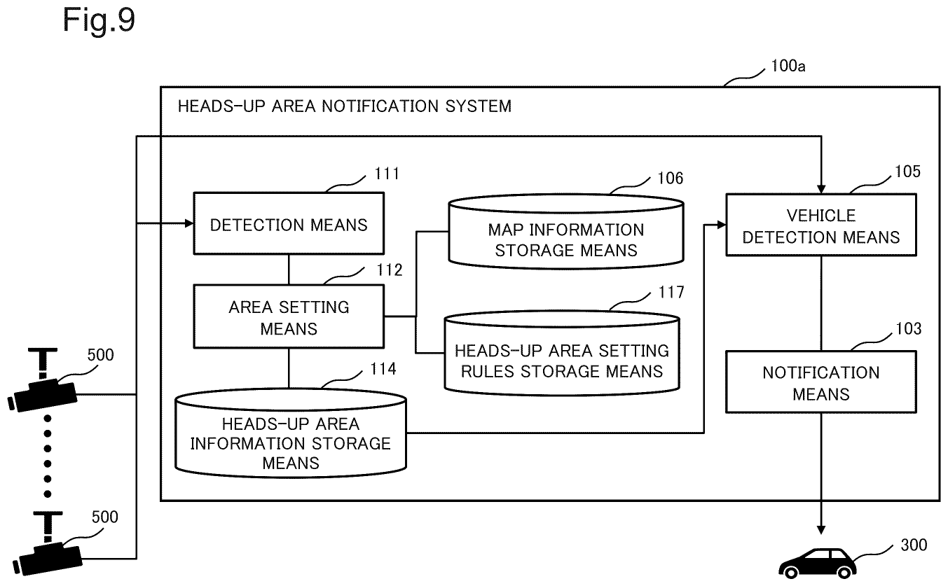

Next, a second example embodiment in which the above-described heads-up area notification system 100 sets a heads-up area for each type of moving object will be described in detail with reference to the diagrams. FIG. 9 is a diagram illustrating the configuration of a heads-up area notification system according to the second example embodiment of the present invention. The difference from the first example embodiment illustrated in FIG. 5 is a detection means 111, an area setting means 112, and a heads-up area setting rules storage means 117. Since the other configurations are similar to those of the first example embodiment, differences thereof will be mainly described below.

The detection means 111 of the present example embodiment can specify the attribute or type of a moving object in addition to the presence of the moving object.

The heads-up area setting rules storage means 117 of the present example embodiment stores heads-up area setting rules set for each attribute or type of the moving object.

The area setting means 112 of the present example embodiment sets different heads-up areas based on the attribute or type of the moving object specified by the detection means 111 referring to the rules stored in the heads-up area setting rules storage means 117.

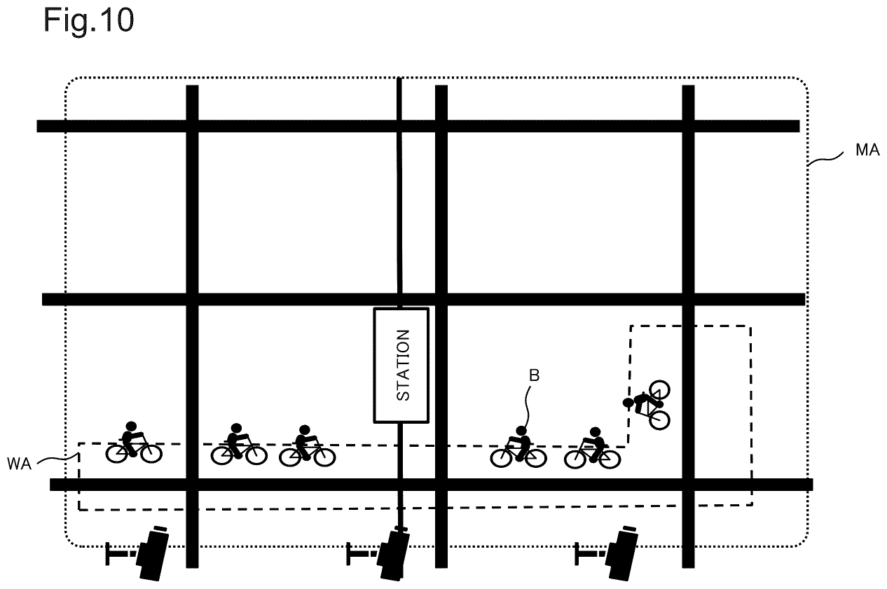

FIG. 10 is a diagram illustrating an example of the heads-up area set by a heads-up area notification system 100a according to the second example embodiment. In the example of FIG. 10, the heads-up area notification system 100a detects a bicycle B as a moving object, and sets a heads-up area WA using the rules for bicycles. By setting such a heads-up area WA, it is possible to set a heads-up area in consideration of bicycles during morning and evening rush hour.

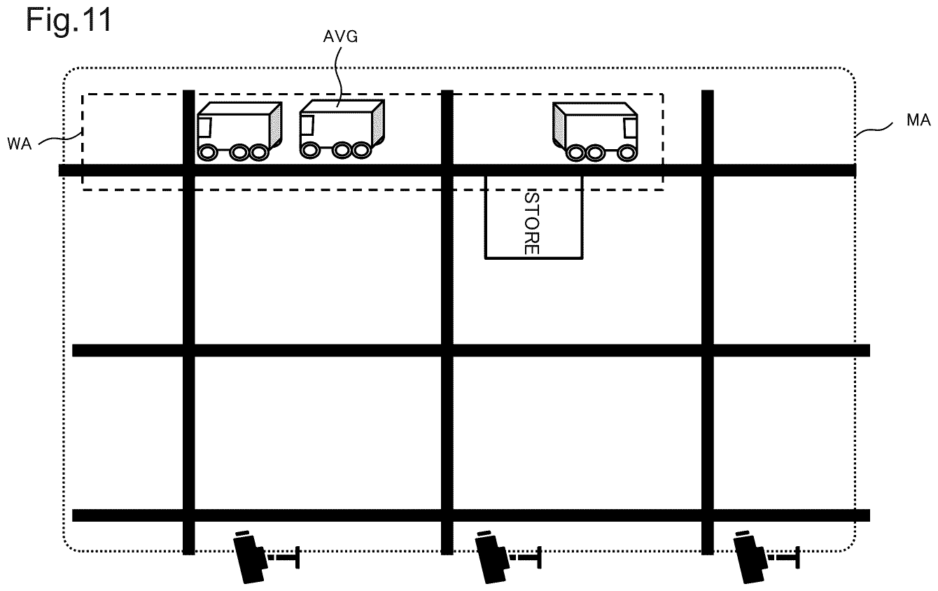

FIG. 11 is a diagram illustrating another example of the heads-up area set by the heads-up area notification system 100a according to the second example embodiment. In the example of FIG. 11, the heads-up area notification system 100a detects a delivery robot AVG as a moving object, and sets the heads-up area WA using the rules for delivery robots. By setting such a heads-up area WA, it is possible to set a heads-up area in consideration of the delivery robot AVG that travels at a low speed on a sidewalk or the like to perform delivery.

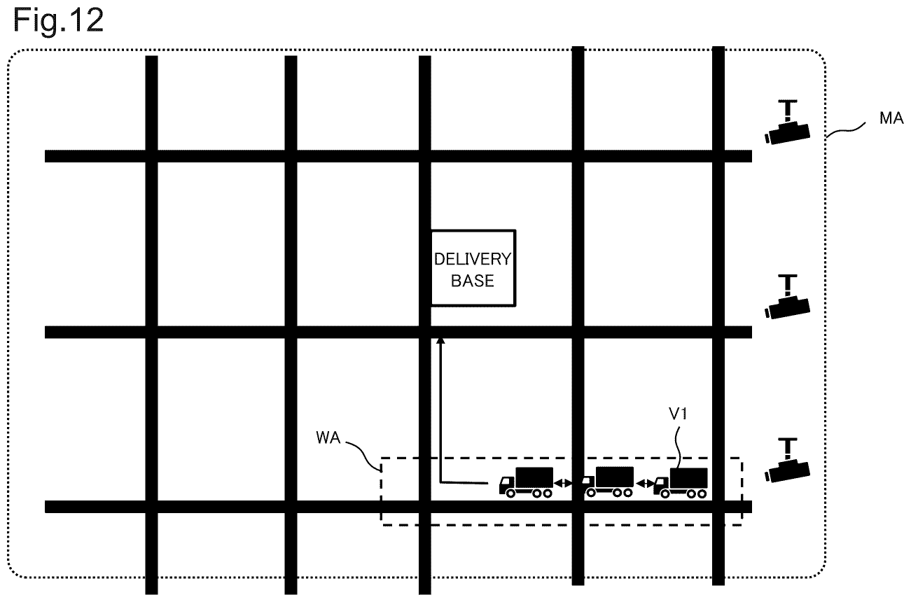

FIG. 12 is a diagram illustrating another example of the heads-up area set by the heads-up area notification system 100a according to the second example embodiment. In the example of FIG. 12, the heads-up area notification system 100a detects a vehicle platoon V1 as a moving object, and sets the heads-up area WA using the rules for the vehicle platoon V1. In the example of FIG. 12, the heads-up area notification system 100a sets a heads-up area extending in the traveling direction of the vehicle platoon V1. As a result, it is possible to give a warning early to a vehicle approaching from the road in the traveling direction of the vehicle platoon V1.

As described above, according to the present example embodiment, it is possible to set the heads-up area according to the type and attribute of the moving object and give a warning to the entering vehicle.

### Third Example Embodiment

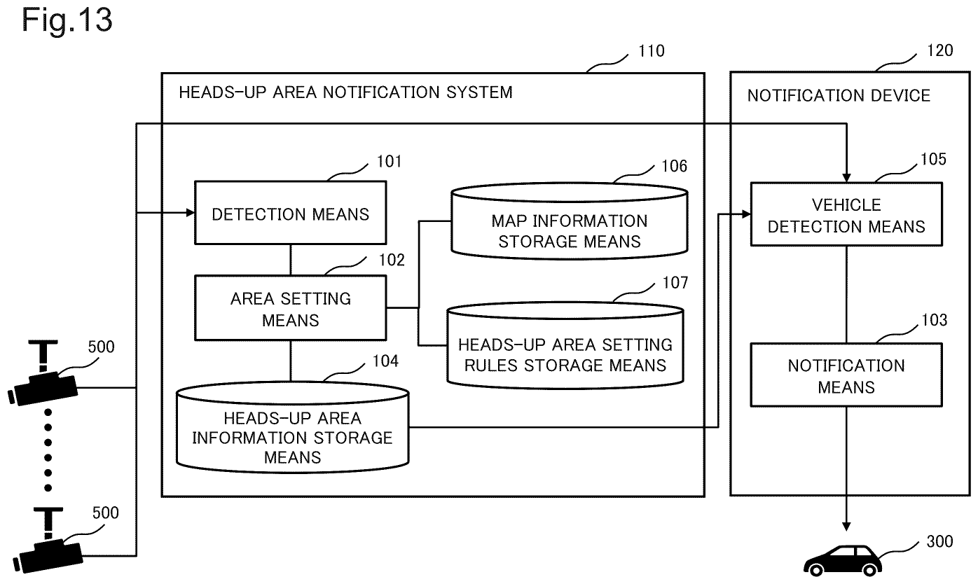

Next, a third example embodiment in which the heads-up area setting function and the notification function of the heads-up area notification system 100 are distributed in separate devices will be described in detail with reference to the diagrams. FIG. 13 is a diagram illustrating the configuration of a heads-up area notification system according to a third example embodiment of the present invention. The difference from the first example embodiment illustrated in FIG. 5 is that the heads-up area notification system 100 includes two devices of a heads-up area setting device 110 and a notification device 120. Since functional elements of the respective devices are similar to those in the first example embodiment, description thereof will be omitted.

According to the present example embodiment, a plurality of notification devices 120 can be arranged for one heads-up area setting device 110. The notification devices 120 are distributed in the monitoring area, and each of the notification devices 120 detects the entry of a vehicle into the area assigned to each device and performs notification. Therefore, even when there are many target vehicles, it is possible to prevent a delay or the like in notification based on the heads-up area.

Although the example embodiments of the present invention have been described above, the present invention is not limited to the above-described example embodiments, and further modifications, substitutions, and adjustments can be made without departing from the basic technical idea of the present invention. For example, the network configuration, the configuration of each element, and the representation form of data illustrated in the diagrams are examples to help understand the present invention, and are not limited to the configurations illustrated in the diagrams.

For example, in the first to third example embodiments described above, an example has been described in which a pedestrian, a bicycle, a delivery robot, and a vehicle platoon are targeted as moving objects, but other moving objects may be detected by the heads-up area notification system. Although the above example embodiments have been described on the assumption that pedestrians are uniformly detected, the heads-up area may be set with a weak traffic person, such as a child or an elderly person, as a detection target, for example.

Although the above example embodiments have been described on the assumption that vehicles that have entered the heads-up area are uniformly detected, a configuration may be adopted in which a specific vehicle type, a vehicle having a specific feature, or the like is selected and notified. For example, by setting a vehicle wearing a beginner mark or an elderly mark as a notification target, it is possible to give a warning only to these vehicles. By setting a vehicle traveling at a predetermined speed or more or a vehicle having a dangerous sign such as wobble as a notification target, it is possible to give a warning only to these vehicles.

### (Regarding Hardware Configuration)

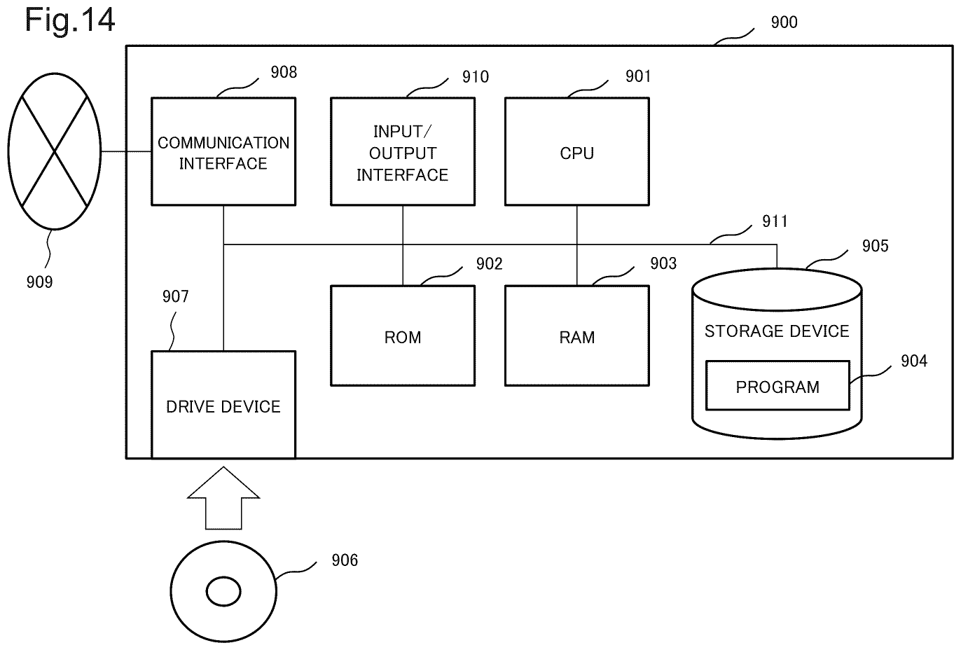

In each example embodiment of the present disclosure, each constituent element of each device indicates a block of a functional unit. Constituent elements of each device are partly or entirely achieved by, for example, any combination of an information processing device 900 and a program as illustrated in FIG. 14. FIG. 14 is a block diagram illustrating an example of the hardware configuration of the information processing device 900 that achieves each constituent element of each device. As an example, the information processing device 900 includes the following constituent elements.
CPU (Central Processing Unit) 901.
ROM (Read Only Memory) 902
RAM (Random Access Memory) 903
Program 904 loaded to the RAM 903
Storage device 905 that stores the program 904
Drive device 907 for reading and writing data from and to a recording medium 906
Communication interface 908 that connects to a communication network 909
Input/output interface 910 for input/output of data
Bus 911 that connects constituent elements to each other

Each constituent element of each device in each example embodiment is achieved by the CPU 901 acquiring and executing the program 904 for achieving these functions. That is, the CPU 901 in FIG. 14 may execute a data collection program or a map update program to perform update processing of each calculation parameter stored in the RAM 903, the storage device 905, or the like. The program 904 for achieving the function of each constituent element of each device is stored in the storage device 905 or the ROM 902 in advance, for example, and is read out by the CPU 901 as necessary. The program 904 may be supplied to the CPU 901 through the communication network 909, or may be stored in advance in the recording medium 906, and the drive device 907 may read out the program and supply the program to the CPU 901.

The program 904 can display the processing result including an intermediate state for each stage through a display device as necessary, or can communicate with the outside through the communication interface. The program 904 can be recorded on a computer-readable (non-transitory) recording medium.

There are various modifications of the implementation method of each device. For example, each device may be achieved by any combination of the information processing device 900 and the program which are separate for each constituent element. A plurality of constituent elements included in each device may be achieved by any combination of one information processing device 900 and a program. That is, each unit (processing means and function) of the heads-up area notification system described in the above-described first to third example embodiments can be achieved by a computer program that causes a processor mounted in the device to execute each of the above-described processes using the hardware.

Constituent elements of each device are partially or entirely achieved by another general-purpose or dedicated circuit, processor, or the like, or a combination thereof. These may be configured by a single chip or may be configured by a plurality of chips connected through a bus. Constituent elements of each device may be partially or entirely achieved by a combination of the above-described circuit or the like and a program.

When constituent elements of each device are partially or entirely achieved by a plurality of information processing devices, circuits, and the like, the plurality of information processing devices, circuits, and the like may be arranged in a centralized manner or in a distributed manner. For example, the information processing devices, the circuits, and the like may be achieved as a form in which each is connected through a communication network, such as a client and server system or a cloud computing system.

Each of the above-described example embodiments is a preferred example embodiment of the present disclosure, and the scope of the present disclosure is not limited only to each of the above-described example embodiments. That is, it is possible for those of ordinary skill in the art to make modifications and substitutions of the above-described example embodiments without departing from the gist of the present disclosure, and to construct a mode in which various changes are made.

Some or all of the above-described example embodiments may be described as the following Supplementary Notes, but are not limited to the following description.

### [Supplementary Note 1]

A heads-up area setting device including:
a detection means for detecting a moving object located in a predetermined monitoring area; and
an area setting means for determining a range of a heads-up area based on an arrangement situation of the moving object in the monitoring area.

### [Supplementary Note 2]

It is possible to adopt a configuration in which the area setting means of the heads-up area setting device described above determines a heads-up area covering the moving object located in the predetermined monitoring area.

### [Supplementary Note 3]

It is possible to adopt a configuration in which the area setting means of the heads-up area setting device described above determines the heads-up area by selecting an area having a density of the moving object equal to or greater than a predetermined value from sections obtained by dividing the monitoring area in accordance with a predetermined standard.

### [Supplementary Note 4]

It is possible to adopt a configuration in which the area setting means of the heads-up area setting device described above determines the heads-up area by excluding an area having a density of the moving object equal to or less than a predetermined value from sections obtained by dividing the monitoring area in accordance with a predetermined standard.

### [Supplementary Note 5]

It is possible to adopt a configuration in which
the detection means of the heads-up area setting device described above is capable of identifying an attribute or a type of the moving object and
the area setting means changes the range of the heads-up area based on the attribute or the type of the moving object.

### [Supplementary Note 6]

The heads-up area setting device described above can adopt a configuration in which one of a pedestrian, a bicycle, a vehicle platoon, and a delivery robot is identified as an attribute or a type of the moving object.

### [Supplementary Note 7]

The heads-up area setting device described above can adopt a configuration further including
a notification means for transmitting a notification for informing of presence of the heads-up area to a vehicle entering the heads-up area.

### [Supplementary Note 8]

The heads-up area setting device described above can adopt a configuration in which
an attribute or a type of a vehicle entering the heads-up area is further identifiable and
the notification means transmits the notification to a vehicle having a specific attribute or type among vehicles entering the heads-up area.

### [Supplementary Note 9]

A heads-up area notification system including:
a detection means for detecting a moving object located in a predetermined monitoring area;
an area setting means for determining a range of a heads-up area based on an arrangement situation of the moving object in the monitoring area; and
a notification means for transmitting a notification for informing of presence of the heads-up area to a vehicle entering the heads-up area.

### [Supplementary Note 10]

A heads-up area setting method including:
detecting a moving object located in a predetermined monitoring area; and
determining a range of a heads-up area based on an arrangement situation of the moving object in the monitoring area.

### [Supplementary Note 11]

A computer-readable recording medium storing a program causing a computer to execute:
processing for detecting a moving object located in a predetermined monitoring area; and
processing for determining a range of a heads-up area based on an arrangement situation of the moving object in the monitoring area.

The aspects of Supplementary Notes 9 to 11 described above can be developed in the aspects of Supplementary Notes 2 to 8 as in Supplementary Note 1.

The disclosure of the above Patent Literatures is incorporated herein by reference, and can be used as a basis or a part of the present invention as necessary. Within the scope of the entire disclosure (including claims) of the present invention, it is possible to further modify and adjust the example embodiments or examples further based on the basic technical idea. Various combinations or selections (including partial deletions) of various disclosed elements (including each element of each claim, each element of each example embodiment or example, each element of each diagram, and the like) can be made within the scope of the disclosure of the present invention. That is, it is needless to say that the present invention includes various modifications and corrections that can be made by those skilled in the art in accordance with the entire disclosure including the claims and the technical idea. In particular, for numerical ranges set forth herein, any numerical value or sub-range included within the range should be construed as being specifically described, even if not stated otherwise. It is also deemed that the matters disclosed in the Literatures cited above are included in the matters disclosed in the present application to use a part or all of the matters disclosed in the Literatures in combination with the matters described in the present specification as a part of the disclosure of the present invention according to the gist of the present invention as necessary.

### REFERENCE SIGNS LIST

10, 100, 100a heads-up area notification system
11 detection means
12 area setting means
13 notification means
100 heads-up area notification system
101, 111 detection means
102, 112 area setting means
103 notification means
104 heads-up area information storage means
105 vehicle detection means
106 map information storage means
107, 117 heads-up area setting rules storage means
110 heads-up area setting device
120 notification device
300 vehicle
500 camera
900 information processing device
901 central processing unit (CPU)
902 read only memory (ROM)
903 random access memory (RAM)
904 program
905 storage device
906 recording medium
907 drive device
908 communication interface
909 communication network
910 input/output interface
911 bus
AVG delivery robot
B bicycle
MA monitoring area
P, P1 to P5 pedestrian
V1 vehicle platoon
WA heads-up area
Z1 to Z9 grid (section)

What is claimed is:

1. A heads-up area setting device comprising:
at least one memory configured to store instructions; and
at least one processor configured to execute the instructions to:
detect a moving object located in a predetermined monitoring area; and
determine a range of a heads-up area based on an arrangement situation of the moving object in the monitoring area.

2. The heads-up area setting device according to claim 1, wherein the at least one processor is further configured to execute the instructions to:
determine a heads-up area covering the moving object located in the predetermined monitoring area.

3. The heads-up area setting device according to claim 1, wherein the at least one processor is further configured to execute the instructions to:
determine the heads-up area by selecting an area having a density of the moving object equal to or greater than a predetermined value from sections obtained by dividing the monitoring area in accordance with a predetermined standard.

4. The heads-up area setting device according to claim 1, wherein the at least one processor is further configured to execute the instructions to:
determine the heads-up area by excluding an area having a density of the moving object equal to or less than a predetermined value from sections obtained by dividing the monitoring area in accordance with a predetermined standard.

5. The heads-up area setting device according to claim 1, wherein the at least one processor is further configured to execute the instructions to:
identify an attribute or a type of the moving object; and
change the range of the heads-up area based on the attribute or the type of the moving object.

6. The heads-up area setting device according to claim 1, wherein the moving object is one of a pedestrian, a bicycle, a vehicle platoon, and a delivery robot.

7. The heads-up area setting device according to claim 1, wherein the at least one processor is further configured to execute the instructions to:
transmit a notification for informing of presence of the heads-up area to a vehicle entering the heads-up area.

8. The heads-up area setting device according to claim 7, wherein the at least one processor is further configured to execute the instructions to:
identify an attribute or a type of a vehicle entering the heads-up area; and
transmit the notification to a vehicle having a specific attribute or type among vehicles entering the heads-up area.

9. (canceled)

10. A heads-up area setting method comprising:
detecting a moving object located in a predetermined monitoring area; and
determining a range of a heads-up area based on an arrangement situation of the moving object in the monitoring area.

11. A non-transitory computer-readable recording medium storing a program causing a computer to execute:
processing for detecting a moving object located in a predetermined monitoring area; and
processing for determining a range of a heads-up area based on an arrangement situation of the moving object in the monitoring area.
